(19) United States
(12) Patent Application Publication
(10) Pub. No.: US 2004/0008949 A1
(43) Pub. Date: Jan. 15, 2004

(54) Fiber optic connection system and method of using the same

(76) Inventors: Gang Liu, Novi, MI (US); Robert F. Rubock, Jefferson, MD (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/176,501

(22) Filed: Jun. 21, 2002

(51) Int. Cl. G02B 6/36

(52) U.S. Cl. 385/77

(57) ABSTRACT

A fiber optic connector comprises a body and a cable guide. The body comprises a first end for interfacing with a fiber optic transceiver and a second end for receiving a fiber optic cable. The body includes a passage from the first end of the body to the second end of the body for receiving the cable. The cable guide comprises a first end having a first inner perimeter and a second end having a second inner perimeter. The cable guide includes a passage from the first end of the cable guide to the second end of the cable guide for receiving the fiber optic cable. The first end of the cable guide is coupled to the second end of the body. The length of the first inner perimeter is less than the length of the second inner perimeter, thereby limiting bending of a portion of the fiber optic cable within and proximate the cable guide and allowing radial movement of the fiber optic cable within the cable guide.

### FIELD OF THE INVENTION

The invention generally relates to data communication over power lines and more particularly, to fiber optic connectors, cable assemblies, signal transceivers, and connection systems for connecting between communication devices.

### BACKGROUND OF THE INVENTION

A well-established electrical power distribution system exists throughout most of the United States and other countries. The power distribution system provides power to customers via power lines. With some modification and/or by adding additional components, the infrastructure of the existing power distribution system can be used to provide data communication—including voice, video, audio, and other data—in addition to power delivery. That is, data signals can be transmitted through the existing power lines that already have been run to many homes and offices.

While the concept may sound simple, there are many challenges to overcome before using power lines for data communication. Transformers in the power system are one obstacle to using power distribution lines for data communication. Transformers convert voltages from and to different voltage levels among different portions of the power distribution system. For example, a power distribution system may include a high voltage portion, a medium voltage portion, and a low voltage portion. Transformers convert from the voltage of one portion (e.g., a medium voltage portion) to the voltage of another portion (e.g., the low voltage portion). Transformers, however, act as a low-pass filter, passing low frequency signals (e.g., 50 or 60 Hz power signals) and impeding high frequency signals (e.g., such as the frequencies in the kilo-Hertz to mega-Hertz which are typically used for data communication) from passing through the transformer.

To overcome such high frequency filtering effects, data signals on the power lines may be converted to optic signals to “bypass” around the transformer that would otherwise filter the data signals. The optic signals are typically carried by fiber optic cables. In a typical power line communication system, there is one fiber optic connection for each transformer, which serves from one to ten homes. Most fiber optic cables and their associated connectors are expensive devices and a fiber optic cable may be installed at each transformer in a power line data communication system. Therefore, the cost of using conventional fiber connections on multiple transformers may reduce the cost effectiveness of a power line data communication system

Also, conventional fiber optic cables and connectors typically are fragile devices that are relatively sensitive to mechanical shocks and vibrations and, therefore, are not well adapted to operation in an outdoor environment. For example, a conventional fiber optic cable is typically very sensitive to contaminants, scratches, and the like that may be experienced in an outdoor environment. Conventional fiber optic cables are typically cut to length, cleaned, polished, and installed in an indoor environment or within a housing for protection. Therefore, conventional fiber optic cables and connectors may not be rugged enough to reliably operate in the outdoor conditions associated with a power line communication system.

Also, the installation of conventional fiber optic cables and connectors often requires a skilled technician with good manual dexterity. For example, a conventional fiber optic cable includes a nine micron optic fiber that is inserted in a precision ferrule for alignment to a mating connector. A nine micron optic fiber has a much smaller diameter less than that of a typical human hair and, therefore, is difficult to handle and breaks easily. Moreover, applying a conventional fiber optic connector to a power line communication system adds additional challenges. For example, the fiber optic connection is typically performed by a lineman that has not been trained in making fiber optic connections (and therefore is not typically familiar with polishing and cleaning optic fibers). Moreover, the connection is often performed many feet in the air from a bucket truck that often sways with the wind. Further exacerbating an already difficult situation, lineman often wear thick gloves that offer protection, but reduce their dexterity.

Therefore, a need exists for a fiber optic connection system that can be easily installed, is relatively inexpensive, and is designed for outdoor environmental conditions.

### SUMMARY OF THE INVENTION

The present invention is directed to a fiber optic connection system, and method of using the same. The fiber optic connection system includes a fiber optic cable assembly and a fiber optic transceiver. The fiber optic cable assembly comprises a first fiber optic connector, a second fiber optic connector, and a fiber optic cable coupled between the first and second connector.

Each fiber optic connector includes a fiber optic cable, a body, and a cable guide. The body comprises a first end for interfacing with a fiber optic transceiver and a second end for receiving a fiber optic cable. The body includes a passage from the first end of the body to the second end of the body for communicating optical signals. The cable guide comprises a first end having a first inner perimeter and a second end having a second inner perimeter. The cable guide includes a passage from the first end of the cable guide to the second end of the cable guide for receiving the fiber optic cable. The first end of the cable guide is coupled to the second end of the body. The length of the first inner perimeter is less than the length of the second inner perimeter, thereby limiting bending of a portion of the fiber optic cable within and proximate the cable guide and allowing radial movement of the fiber optic cable within the cable guide.

The fiber optic cable has a first end and a second end. The first end of the cable is disposed in the cable guide passage of the first connector whereby bending of the first end of the cable is limited by the cable guide of the first connector and radial movement of the first end of the fiber optic cable is allowed within the cable guide. The second end of the cable is disposed in the cable guide passage of the second connector whereby bending of the second end of the cable is limited by the cable guide of the second connector and radial movement of the second end of the fiber optic cable is allowed within the cable guide.

The fiber optic transceiver comprises a light sensing device and a light producing device. The light sensing device is aligned to communicate with a first optic fiber. The light sensing device has an effective communication area that is responsive to light and the first optic fiber has a communication area for communicating light. The communication area of the light sensing device that is responsive to light is larger than, or the same size as, the communication area for communicating light of the first optic fiber. The light producing device is aligned to communicate with a second optic fiber. The light producing device has a communication area that emits light and the second optic fiber has a communication area for communicating light. The communication area of the light producing device that emits light is larger than, the same size, or smaller than, the communication area for communicating light of the second optic fiber.

The above-listed features, as well as other features, of the invention will be more fully set forth hereinafter.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of an exemplary power distribution system with which the invention may be employed;

FIG. 2 is a block diagram of an illustrative fiber optic connection between a power line coupler and a power line bridge, in accordance with an embodiment of the invention;

FIG. 3 is a diagram of an illustrative fiber optic connection on an exemplary power line pole of the power distribution system, in accordance with an embodiment of the invention;

FIG. 4 is a side view of a component part of an illustrative fiber optic connector, in accordance with an embodiment of the invention;

FIG. 5 is a side view of a component part of an illustrative fiber optic connector, in accordance with an embodiment of the invention;

FIG. 6 is a side view of the mating component part of the illustrative fiber optic connector shown in FIGS. 4 and 5;

FIG. 7 is a perspective view of a portion of an illustrative transceiver, in accordance with an embodiment of the invention;

FIG. 8 is a diagram of an illustrative transceiver and illustrative optic fibers, in accordance with an embodiment of the invention;

FIG. 9 is a detailed side view of a portion of an illustrative fiber optic transceiver; and

FIG. 10 is a side view of a component part of another illustrative fiber optic connector, in accordance with an embodiment of the invention.

### DETAILED DESCRIPTION OF ILLUSTRATIVE EMBODIMENTS

Power Line Communication System

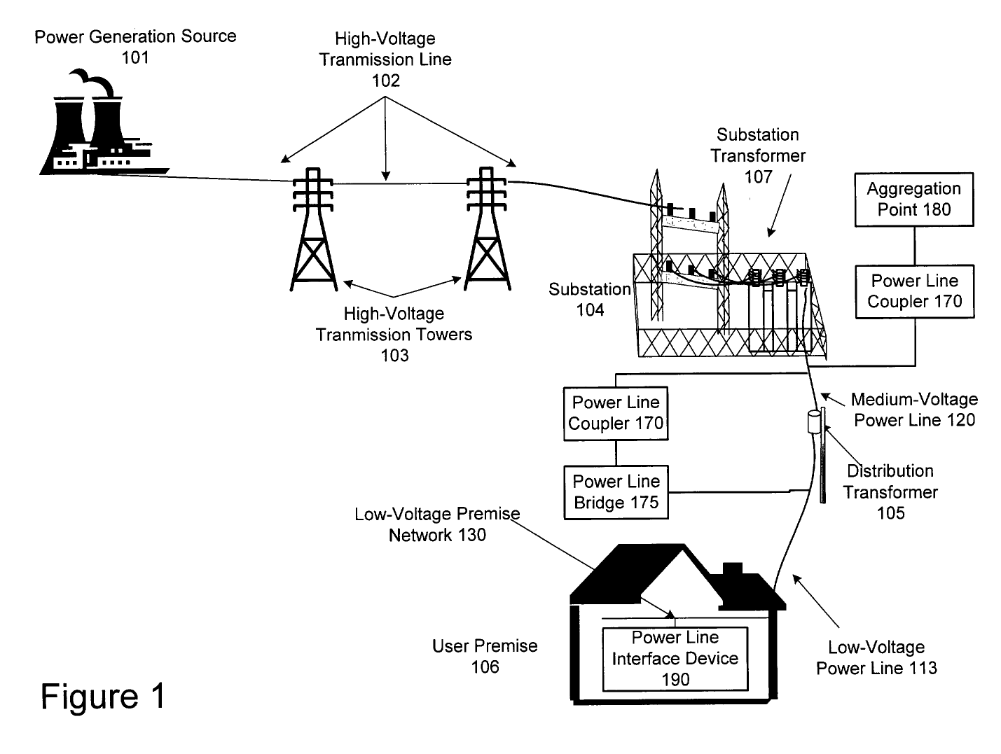

An exemplary power line communication system is shown in FIG. 1. As shown in FIG. 1, the power line communication system is implemented on a medium-voltage half loop power distribution system that is common to the United States. The invention, however, may be employed with other power distribution systems, such as, for example, a high-voltage delivery system that is common to European countries, as well as other power distribution systems.

The power distribution system includes components for power generation, power transmission, and power delivery. As shown in FIG. 1, the power distribution system includes a power generation source 101 that produces electric power. Power generation source 101 includes a generator (not shown) that creates the electrical power. The generator may be a gas turbine or a steam turbine operated by burning coal, oil, natural gas, or a nuclear reactor, for example. Power generation source 101 typically provides three-phase AC power. The generated AC power typically has a voltage as high as approximately 25,000 volts (V).

A transmission substation (not shown) increases the voltage from power generation source 101 to high-voltage levels for long distance transmission on high-voltage transmission line 102. Typical voltages found on high-voltage transmission line 102 range from 69 kilovolts (kV) to in excess of 800 kV. High-voltage transmission line 102 is supported by high-voltage transmission towers 103. High-voltage transmission towers 103 are large metal support structures attached to the earth, so as to support transmission line 102 and to provide a ground potential to the power distribution system. High-voltage transmission line 102 carries the electric power from power generation source 101 to a substation 104 for distribution of power to other portions of the power system.

In addition to high-voltage transmission line 102, the power distribution system includes medium-voltage power line 120 and low-voltage power line 113. Medium-voltage typically is from about 7 kV to about 32 kV and low-voltage typically is from about 100 V to about 240 V. As can be seen, power distribution systems typically have different voltage portions and transformers are used to convert between the respective voltage portions, e.g., between the high-voltage portion and the medium-voltage portion and between the medium-voltage portion and the low-voltage portion.

One such transformer is substation transformer 107 that is located at substation 104. Substation 104 acts as a distribution point in the power distribution system and substation transformer 107 steps-down voltages to reduced voltage levels. Specifically, substation transformer 107 converts the power on high-voltage transmission line 102 from high-voltage levels to medium-voltage levels for medium-voltage power line 120. In addition, substation 104 may include an electrical bus (not shown) that serves to route the medium-voltage power in multiple directions. Furthermore, substation 104 often includes circuit breakers and switches (both not shown) that permit substation 104 to be disconnected from high-voltage transmission line 102 when a fault occurs.

Substation 104 typically distributes power to a plurality of distribution transformers 105. Each distribution transformer 105 may be a pole-top transformer located on a utility pole, a pad-mounted transformer located on the ground, or a transformer located under ground level. Distribution transformer 105 steps down the voltage to levels appropriate for a user premise 106, for example. Power is carried from distribution transformer 105 to user premise 106 via low-voltage power line 113. Also, distribution transformer 105 may function to distribute one, two, three, or more phase currents to multiple user premises, such as user premise 106. In the United States, for example, these distribution transformers 105 typically feed anywhere from one to ten homes, depending upon the concentration of user premises in the area, and typically feed two phases of power. From low-voltage power line 113, low-voltage premise network 130 distributes power within user premise 106 via a plurality of electrical circuits. A user draws power on demand by plugging an electrical appliance (not shown) into a power outlet to electrically connect the electrical appliance to the power distribution system.

As described above, a power distribution system typically is separated into high-voltage power lines, medium-voltage power lines, and low-voltage power lines that extend to a user premise 106. These power lines may be used for data communication as well as for power transmission and distribution.

The high-voltage power lines typically have the least amount of noise and least amount of reflections and therefore, these power lines have the highest potential bandwidth for data communications. These high-voltage power lines typically are not used for data communication, however, because of their extremely high-voltage.

The medium-voltage power lines typically have a relatively low amount of noise, and therefore have good potential bandwidth for data communications. This is convenient because it is the portion of the system that concentrates the bandwidth from the low-voltage portions (i.e., receives data from and supplies data to a plurality of users). The type of signal modulation used on this portion can be almost any signal modulation used in communications (Code Division Multiple Access (CDMA), Time Division Multiple Access (TDMA), Frequency Division Multiplex (FDM), Orthogonal Frequency Division Multiplex (OFDM), and the like).

Low-voltage power lines 113 typically have some noise present from electrical appliances and reflections due to the electrical circuits in these portions. These portions of the power distribution system may support a lower bandwidth than the medium-voltage power lines and therefore, may employ a more intelligent modulation scheme (typically with more overhead).

To communicate data signals with the power lines, a power line coupler 170 may be coupled to medium-voltage power line 120, for example. Power line coupler 170 may include a power line coupling device, such as, for example, a current transformer, an inductor, a capacitor, an antenna, and the like (each not shown). To communicate data signals with low-voltage power line 113, a power line bridge 175 may be coupled to low-voltage power line 113. Power line bridge 175 may include a modem, a data router, an electrically non-conductive device, a power line coupling device, and the like (each not shown).

Power line coupler 170 and power line bridge 175 communicate with each other, thereby allowing data signals to bypass transformer 105, and thus avoid the filtering of the high frequency data signal that otherwise would occur in distribution transformer 105. Lower frequency power signals continue to flow from medium-voltage power line 120 to low-voltage power line 113 via transformer 105, thereby providing power to user premise 106.

At user premise 106, a user may plug a power line interface device 190 into a power outlet (not shown) to digitally connect a data appliance (not shown) to communicate data signals carried by low-voltage premise network 130. Also, power line interface device 190 may connect to low-voltage premise network 130 in other ways. Power line interface device 190 serves as an interface for data appliances to access the power line communication system. Power line interface device 190 can have a variety of interfaces for user data appliances. For example, power line interface device 190 can include a RJ-11 Plain Old Telephone Service (POTS) connector, an RS-232 connector, a USB connector, a 10 Base-T connector, and the like. In this manner, a user can connect a variety of data appliances to the power line communication system. Further, multiple power line interface devices 190 can be plugged into power outlets in the user premise 106 with each power line interface device 190 communicating over low-voltage premise network 130 of user premise 106.

Power line interface device 190 converts a signal provided by power line bridge 175 to an appropriate form for communication with a data appliance. For example, power line interface device 190 may convert an analog signal from low-voltage premise network 130 to a digital signal for receipt by a data appliance at user premise 106. Further, power line interface device 190 may convert a digital signal from a data appliance to an analog signal for communication to low-voltage premise network 130.

Service providers may connect to the power line communication system via an aggregation point 180 that operates to allow access to data signals on medium-voltage power line 120 via another power line coupler 170. Aggregation point 180 may include a modem, a backhaul interface, a backhaul link, and the like (each not shown).

Fiber Optic Connection

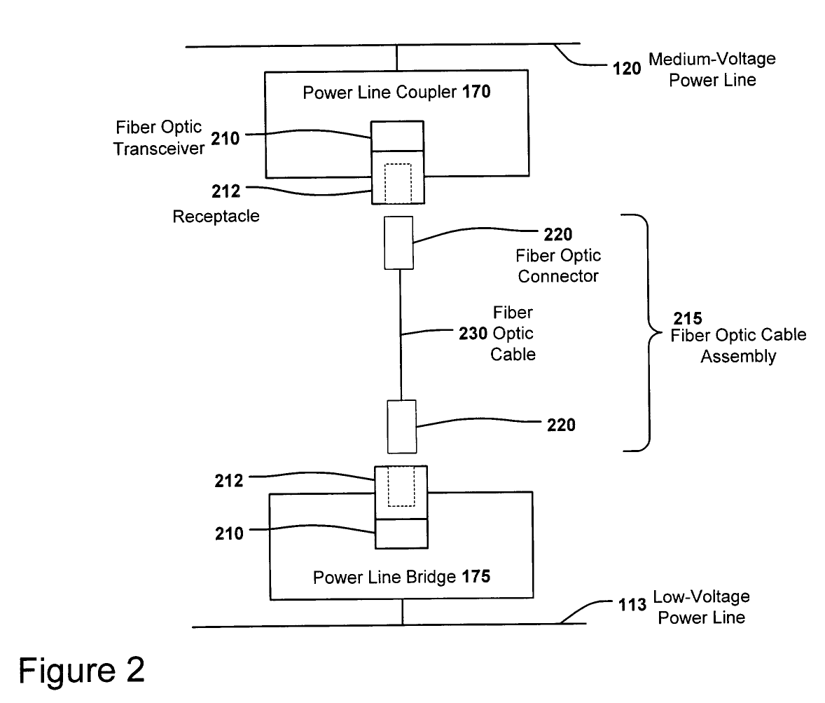

Power line coupler 170 and power line bridge 175 typically are connected with a fiber optic connection. FIG. 2 shows an illustrative fiber optic cable assembly 215 connected between power line coupler 170 and power line bridge 175. As shown in FIG. 2, in this illustrative embodiment power line coupler 170 and power line bridge 175 each comprise a transceiver 210 and a receptacle 212 for connection of fiber optic cable assembly 215. Transceivers 210 communicate light signals through fiber optic cable assembly 215. Receptacles 212 receive a portion of fiber optic cable assembly 215, as described in more detail below. While FIG. 2 shows power line coupler 170 and power line bridge 175 each having a receptacle 212, the invention could be implemented with fiber optic cable assembly 215 having a receptacle at each end thereof and power line coupler 170 and power line bridge 175 each having a mating male connector. In still another alternate embodiment, the fiber optic cable assembly 215 may be fixedly attached at one end and include a connecting member (i.e., a male connector or a receptacle 212) to be removably attached at the other end.

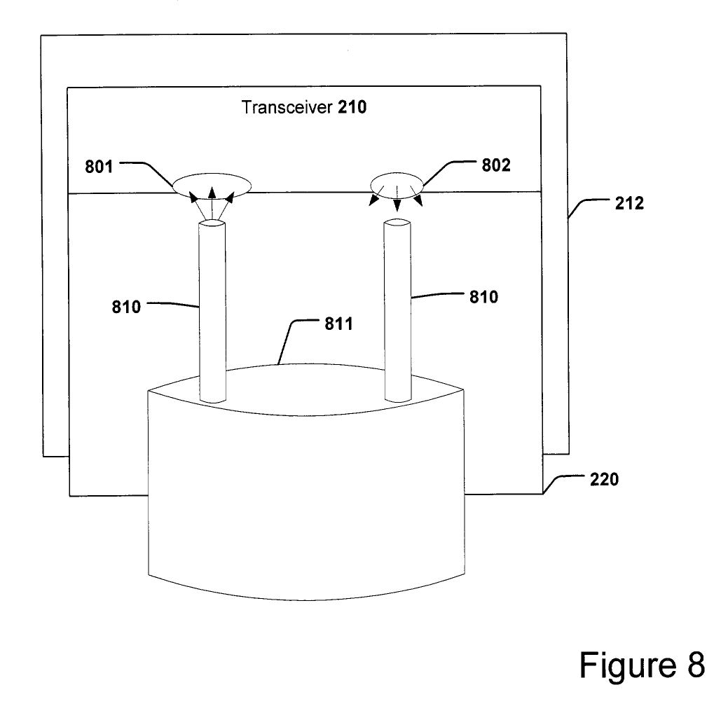

As shown in FIG. 2, fiber optic cable assembly 215 includes a fiber optic cable 230 and a fiber optic connector 220 at each end of fiber optic cable 230. Fiber optic cable 230 preferably includes a plurality of optic fibers and a jacket (as discussed with reference to FIG. 8), as described in more detail below. Fiber optic cable assembly 215 provides a light path, which is a conductive communication medium that is non-electrical, between power line coupler 170 and power line bridge 175, and therefore provides electrical isolation between medium-voltage power line 120 and low-voltage power line 113. Fiber optic cable assembly 215, being electrically non-conductive, provides the increased safety that is desired by substantially limiting power flow through fiber optic cable assembly 215. Fiber optic cable assembly 215 typically is about fifteen feet long, although any appropriate length is possible. Fiber optic cable assembly 215 typically draws negligible leakage current during a high-pot test at 50,000 V.

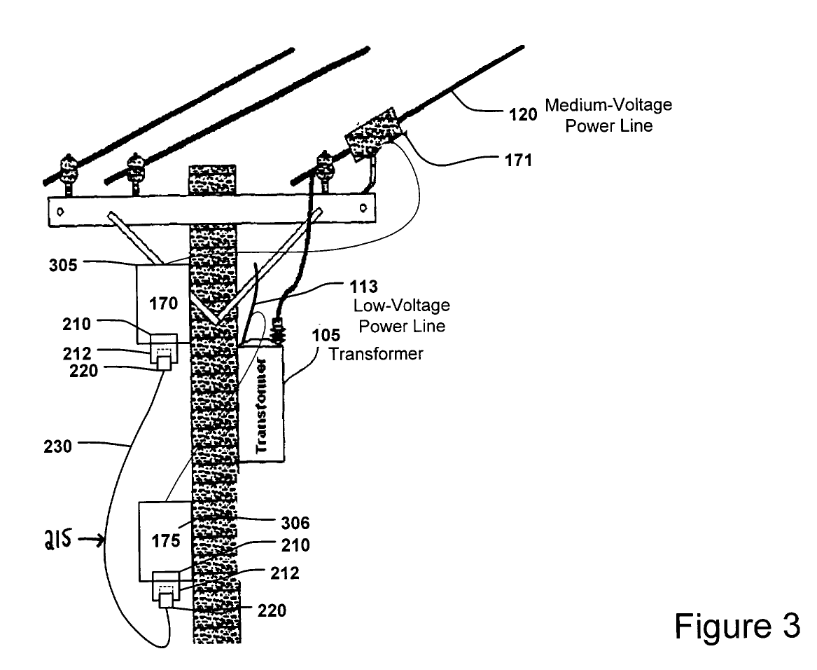

FIG. 3 shows an illustrative installation of fiber optic cable assembly 215, power line coupler 170, and power line bridge 175 to an exemplary power line pole of a power distribution system. As shown in FIG. 3, power line coupler 170 is mounted to the power line pole proximate medium-voltage power line 120, and power line bridge 175 is mounted to the power line pole proximate low-voltage power line 113.

Power line coupler 170 receives data signals from medium-voltage power line 120 and transceiver 210 of power line coupler 170 converts the data signals to light data signals. Power line coupler 170 communicates the light data signals to fiber optic cable assembly 215. Transceiver 210 of power line coupler 170 receives light data signals from fiber optic cable assembly 215 and converts the light data signals to data signals for communication to medium-voltage power line 120.

To communicate with medium-voltage power line 120, power line coupler 170 includes a power line coupling device 171. Power line coupling device 171 may include, for example, a current transformer, a capacitor, an antenna, and the like (each not shown). In one illustrative embodiment, the power line coupling device 171 includes an inductor.

To communicate with fiber optic cable assembly 215, power line coupler 170 includes a fiber optic transceiver 210. Fiber optic transceiver 210 converts data signals received from power line 120 to light data signals and vice-versa, as described in more detail below. Fiber optic transceiver 210 typically is mounted in a housing 305 for protection against environmental conditions. Housing 305 may be constructed with high dielectric, corrosive resistant materials, metal, fasteners, adhesives, gaskets, sealed conduit openings, and the like.

Power line coupler 170 further includes a receptacle 212 to receive a portion of fiber optic cable assembly 215 and to secure and align fiber optic cable assembly 215 with fiber optic transceiver 210 to facilitate communications. In other words, fiber optic transceiver 210 is mounted proximate receptacle 212 such that receptacle 212 provides optical access to transceiver 210. Receptacle 212 is preferably mounted on the bottom of housing 305 for increased protection against environmental conditions. Further details of receptacle 212 are provided below.

Power line bridge 175 receives light data signals from fiber optic cable assembly 215 and converts the light data signals to data signals for communication with low-voltage power line 113. Power line bridge 175 communicates the data signals to low-voltage power line 113, and therefore to user premise 106. Power line bridge 175 receives data signals from low-voltage power line 113 and converts the data signals to light data signals. Power line bridge 175 communicates the light data signals to fiber optic cable assembly 215.

To communicate with low-voltage power line 113, power line bridge 175 includes a power line coupling device (not shown) that may include, for example, a current transformer, an inductor, a capacitor, an antenna, and the like.

To communicate with fiber optic cable assembly 215, power line bridge 175 includes a fiber optic transceiver 210 and a receptacle 212, in a similar fashion to power line coupler 170. Fiber optic transceiver 210 is preferably mounted in a housing 306 for protection against environmental conditions. Housing 306 is preferably the housing for the power line bridge 175 and may be constructed with high dielectric, corrosive resistant materials, metal, fasteners, adhesives, gaskets, sealed conduit openings, and the like.

Alternatively, power line bridge 175 may communicate with a data appliance of user premise 106 via communication paths other than low-voltage power line 113. For example, power line bridge 175 may communicate with a data appliance of user premise 106 via a wireless communication link, a telephone line, a cable line, a fiber optic line, and the like. In these embodiments, power line bridge 175 converts the light data signals to a form appropriate for the communication path to user premise 106. For example, if the communication path comprises a wireless communication link, power line bridge 175 converts the light data signal to and from wireless data signals, which are communicated by a wireless transceiver in communication with the computer or other data appliance. If the communication path is a fiber optic line, power line bridge may not perform any conversion of the data signals which are already in light form in fiber optic cable assembly 215.

To provide a communication path between power line coupler 170 and power line bridge 175, a first connector 220 of fiber optic cable assembly 215 is disposed in receptacle 212 of power line coupler 170 and a second connector 220 of fiber optic cable assembly 215 is disposed in receptacle 212 of power line bridge 175.

In the illustrative mating scheme shown in FIG. 3, the connection of fiber optic connectors 220 are made many feet in the air, typically by a lineman in a bucket truck. Further, the lineman typically wears gloves for protection from electrical power. Such gloves typically are very thick and can significantly reduce manual dexterity. As such, fiber optic connectors 220 are designed to be easily installed, relative to some conventional fiber optic connectors.

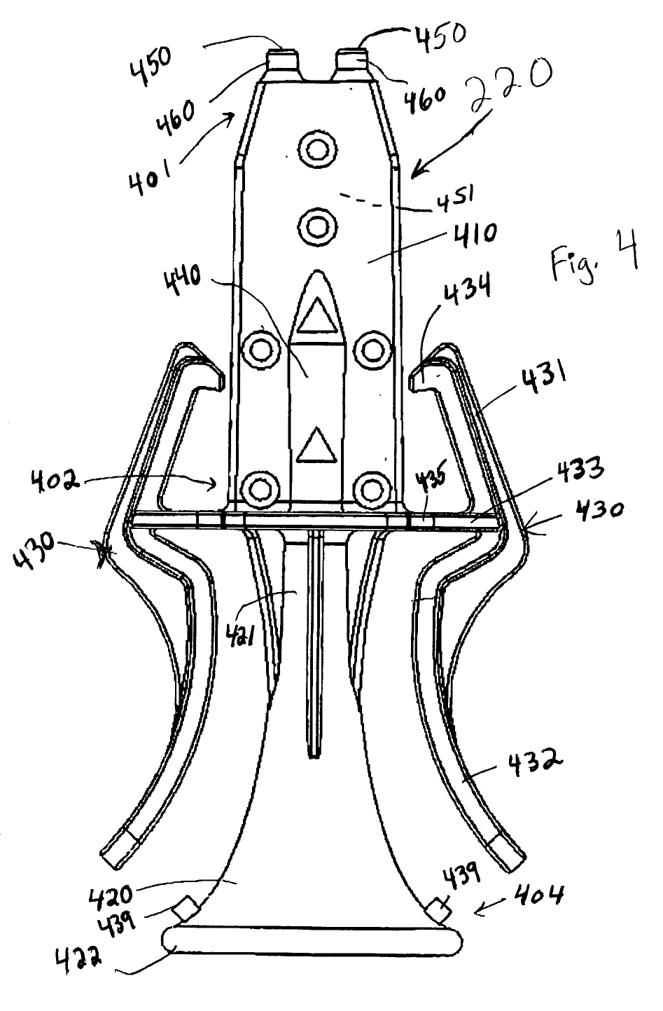

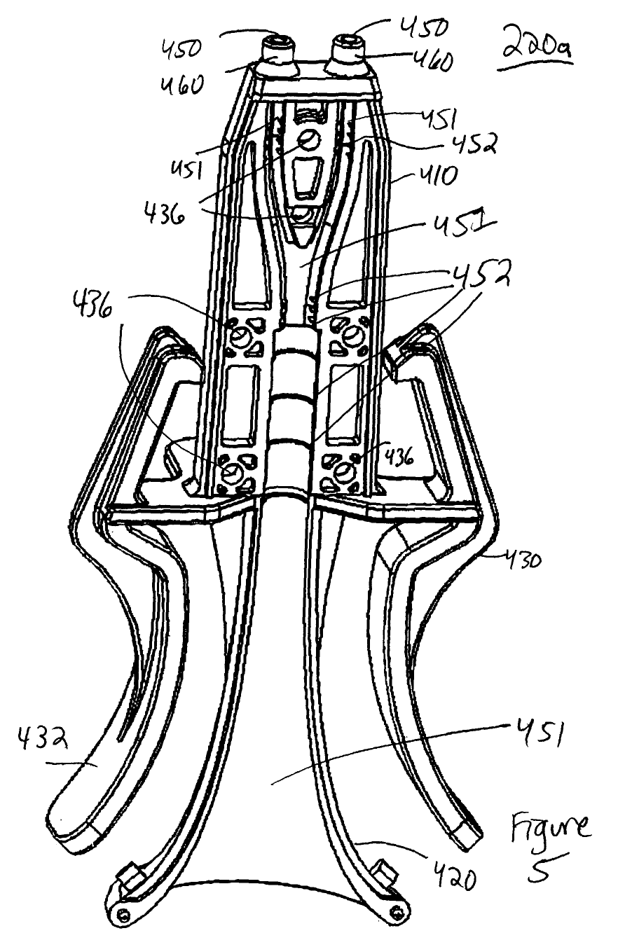

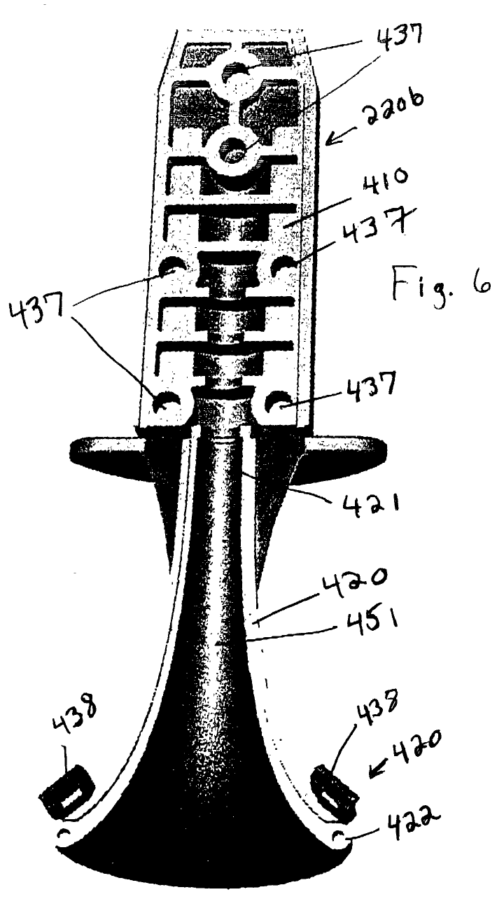

Connector 220 of this illustrative embodiment is formed of two component parts 220a and 220b. One of the two component parts (220a) of connector 220 is shown in detail in FIGS. 4 and 5. FIG. 6 shows the mate (i.e., component part 220b) to the part shown in FIGS. 4 and 5. Once the fiber optic cable is mounted to component part 220a, component part 220b is attached to part 220a with mounting screws (not shown) that protrude through mounting apertures 436 and are received in threaded mounted holes 437 of part 220b. In addition, snaps 438 of part 220b are snapped over tabs 439 of part 220a to further secure the parts together and provide stress relief. As shown in FIGS. 4 and 5, fiber optic connector 220 comprises a body 410 and a cable guide 420.

Body 410 has a first end 401 for interfacing with a fiber optic transceiver 210, a second end 402 that is coupled to cable guide 420, and a passage 451 therethrough for receiving fiber optic cable 230. As shown, body 410 is substantially rectangular; however, body 410 may be any appropriate shape to mate with a corresponding receptacle 212.

Passage 451 extends from first end 401 to second end 402. At first end 401, passage 451 splits into two passages that each culminate in an opening 450 as shown. Each opening 450 is sized to secure an optic fiber and positioned to ensure that the end of the optic fiber is proximate transceiver 210. In addition, portions of the body 410 that define passage 451 include teeth 452 that engage fiber optic cable 230 (or its jacket) to secure fiber optic cable 230 in place when the component parts 220a-b of the connector 220 are secured together. While two openings 450 are shown, there may be any number of openings 450. Openings 450 are at least partially contiguous with passage 451. At second end 402, passage 451 culminates in a single opening that receives fiber optic cable 230. The opening at second end 402 is sized to secure fiber optic cable 230 and a jacket 811 (as discussed with reference to FIG. 8) of fiber optic cable 230. Alternatively, passage 451 may define or contain an optic wave-guide for communication of light signals.

This illustrative embodiment of connector 220 further includes a latching mechanism. In this embodiment, body 410 includes a pair of latches 430 for securing and aligning connector 220 to a corresponding receptacle 212 that comprise the latching mechanism. As shown, each latch 430 includes an elongated section 432 and a latching section 431 and connects to body 410 via laterally extending member 435 at a pivot area 433 disposed between elongated section 432 and latching section 431. In this illustrative embodiment, each latching section 431 includes a latch 434 that extends inwardly toward body 410 and includes a latching surface that extends in toward the body 410 and is also sloped slightly in the direction of removal of the connector 220 as the latching surface gets closer to body 410. When a force is exerted on the connector in the direction of removal of connector 220 from receptacle 212 without the latching mechanism being unlatched (such as by pulling on the cable), the slope of the latching surface of latch 434 will tend to urge latch 434 toward body 410, thereby reducing the likelihood of an accidental removal of connector 220 due to slippage of latch 434 against the protrusion or recess of receptacle 212. In other embodiments the latching surface may be substantially perpendicular to the longitudinal axis of the connector and the direction of insertion into the corresponding receptacle 212. Thus, latches 434 mate with corresponding protrusions or recesses in receptacle 212 to secure connector 220 to receptacle 212.

Elongated sections 432 and cable guide 420, which extend from the receptacle 212 when connected, form a handle portion that is gripped by the lineman or other user. When the handle is gripped, elongated sections 432 are biased towards each other (and towards the cable guide 420) by the force of the grip. When elongated sections 432 are biased towards each other, latching sections 431 are biased apart from each other (and away from body 410), thereby disengaging latches 434 of latching sections 431 from their corresponding protrusions or recess to allow removal of connector 220 from receptacle 212. When the lineman gripping the handle portion releases the grip, the elongated sections 432 are biased apart from each other (by the resilience of the material forming connector 220), and latching sections 431 are biased toward each other. When connector 220 is inserted in receptacle 212 and the grip released, latches 434 of latching sections 431 are urged into the corresponding recess or behind the corresponding protrusion of receptacle 212, thereby securing connector 220 to receptacle 212. Thus, gripping the handle portion of connector 212 pivots latches 434 to an unlatched position (outward in this embodiment) permitting removal from receptacle 212. Likewise, removing the grip pressure from the handle portion permits latches 434 to pivot to a latched position (inwards in this embodiment), which, when connector 212 is positioned in receptacle 212, inhibits accidental removal of connector 220 from receptacle 212.

In this illustrative embodiment, latches 434 engage protrusions formed on the outside of receptacle 212. Alternate embodiments of the present invention may be designed to include latches inserted inside the receptacle. Such latches would then engage a recess (which may or may not be behind a protrusion) that is inside the receptacle so that gripping the handle portion urges the latches inward toward the center of the connector and out of the recess. In another alternative embodiment, the connector may be the female portion that is inserted onto and over a male portion that protrudes from the power line coupler.

Latches 430 secure connector 220 to receptacle 212 and the matching shapes of connector 220 and receptacle 212 ensure (both of which are substantially rectangular) that communication may occur between fiber optic cable 230 and transceiver 210, without ferrules or sleeves to align the optic fiber. Conventional fiber optic connection systems use ferrules to align the optic fibers; however, ferrules are typically very small and difficult to install, especially when wearing gloves. Latches 430, the matching cross-sectional shapes of the connector 220 and the receptacle 212, and other features of the connection system, described in more detail below, assist optic fiber alignment, without the use of ferrules or sleeves.

Preferably, connector 220 also includes a tab 460 extending from first end 401 of body 410 to be received in a corresponding recess of receptacle 212 to further assist in providing alignment between fiber optic cable 230 and transceiver 210. As shown, tab 460 is substantially circular; however, tab 460 may be any appropriate shape to mate with a corresponding recess. As shown, there are two tabs 460, one for each optic fiber of fiber optic cable 230; however, there may be any number of tabs 460 or one tab 460 for alignment of multiple optic fibers.

Connector 220 also preferably includes a key 440 extending from body 410 for mating with a key opening of the correspondingly receptacle 212. Such keying inhibits connector 220 from being installed backwards in a corresponding receptacle 212. As shown, key 440 is substantially shaped as an axial portion of a cylinder; however, key 440 may be any appropriate shape, such as a rectangle, square, or triangle, to mate with a key opening of the corresponding receptacle 212. In addition, the key (or keys) may be positioned at any suitable location, such as off center from the center-line of the surface of the connector 220, to mate with a key opening of the corresponding receptacle 212.

Cable guide 420 has first end 421, a second end 422, and a passage 451 therethrough for receiving fiber optic cable 230. First end 421 of cable guide 420 is coupled to second end 402 of body 410.

First end 421 of cable guide 420 has an opening with a first perimeter and second end 422 of cable guide 420 has an opening with a second perimeter, both of which in this illustration are circular in shape.

The first perimeter is smaller than the second perimeter, so that the fiber optic cable 230 is more limited in radial movement near first end 421 and is more free in radial movement near second end 422. As such, the bending radius of fiber optic cable 230 is limited by cable guide 420. Radial movement is defined as movement that is perpendicular to the longitudinal axis of the cable. In this embodiment, radial movement can also be defined as being away from the center-line of the connector 220, which in this embodiment runs through the center of passage 451 of the cable guide 420. The size of the passage 451, which is based on the inside perimeter of the cable body, increases from the first end 421 toward the second 422. The first and second perimeter are preferably selected such that cable guide 420 limits the bending of fiber optic cable 230 (generally in the portion of fiber optic cable 230 inside cable guide 420 and proximate thereto or, in other words, in the portion of the fiber optic cable 230 exiting the second end 402 of the body 410 and proximate thereto) to a bend radius greater than a minimum bend radius of fiber optic cable 230. (The minimum bend radius is the smallest radius of a bend that the cable is rated to withstand or, in other words, measures how sharply the cable can be bent without loss of either physical or optical performance.) In addition, because the perimeter of second end 422 permits radial movement, the cable 230 is free to exit cable guide 420 along the edge of the perimeter of second end 422 in the general direction that the cable 230 needs to traverse in order to connect the other connector 220, which reduces the likelihood that the cable 230 will be urged to make a sharp bend that is sharper than the cable's minimum bend radius. Furthermore, because the perimeter of second end 422 permits radial movement, the linemen's manipulation of the connector 220 is also less likely to bend the cable beyond the cable's tolerable bend radius. If the cable guide 420 were not present, and cable 230 was not inhibited from making a sharp bend when exiting the body 410 of connector 220, the cable 230 would be more likely to be bent beyond the cable's tolerable bend radius. As shown, cable guide 420 preferably has a generally trumpet like shape, wherein first end 421 has a first inner radius and second end 422 has a second inner radius and the first inner radius is less than the second inner radius. In addition, in this illustrative embodiment, the radius of the cable guide 420 increases substantially parabolically (non-linearly) with the size of the radius increasing at a greater rate nearer second end 422 as compared to at first end 421. Other embodiments of the present invention may include a cable body whose inner perimeter (or opening) increases linearly (as opposed to parabolically) thereby being generally frustoconically shaped. In other embodiments the opening at second end 422 may be shaped as a pentagon, octagon, square, hexagon, triangle, elliptical, or other suitable shape.

Thus, the increase in the inner radius of the cable guide 420 in axial (longitudinal) distance from body 410 provides protection against excessive bending of fiber optic cable 230, as described above, and can also provide environmental protection. For example, if cable guide 420 is oriented with first end 421 above the second end 422, downward moving water, such as may be experienced in rainy outdoor conditions, is deflected away from passage 451 of cable guide 420. As such, body 410 and cable guide 420 form a weather-resistant housing for a portion of fiber optic cable 230.

Cable guide 420 is sized to make installation of connector 220 into receptacle 210 ergonomical. For example, the second perimeter of cable guide 420 is preferably sized to be easily handled when the handler is wearing gloves. Cable guide 420 is preferably about 2.5 inches long from first end 421 to second end 422. Other embodiments of the cable guide may have any suitable length including, but not limited to, ranging from about 1.5 inches long to about 5 inches long. In illustrative connector 220, cable guide 420 has a perimeter of about one and one-half inches at first end 421 and a perimeter of about five inches at second end 422. The perimeter of second end 422 is preferably greater than about four inches, but may be smaller for some applications. Such dimensions, however, are merely illustrative of some embodiments.

Connector 220 (and receptacle 212) is preferably formed from Ultem® (i.e., polyetherimide), which is a high performance polymer manufactured by General Electric Co., which provides a strong, lightweight, thermally stable connector 220. Such characteristics help retain acceptable optical alignment between the optic fibers and transceiver 212 even with vibration, temperature changes, and time. Instead of two component parts 220a-b, body 410 and cable guide 420 may be formed as a unitary piece that is tightened onto the cable after insertion.

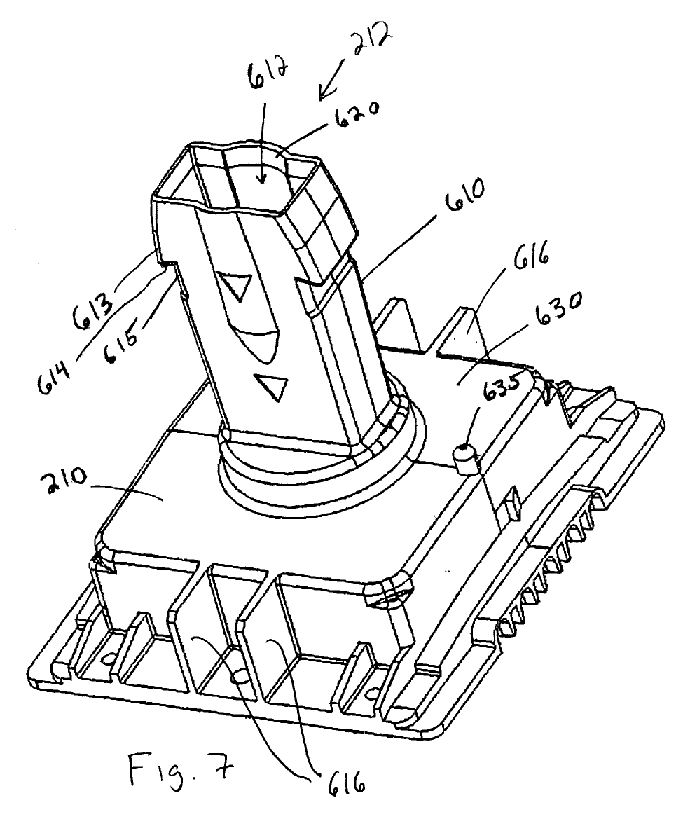

Receptacle 212 is shown in FIG. 7. Receptacle 212 receives connector 220 to align optic fibers with transceiver 210. As shown, receptacle 212 comprises a body 610 and a base portion 630. Body 610 defines a passage 612 therethrough for receiving a corresponding connector 220. In this embodiment, passage 612 of body 610 includes a recess 620 for receiving key 440 of connector 220. Body 610 is substantially rectangular in shape; however, body 610 may be any appropriate shape to mate with connector 220.

Base portion 630 of receptacle 212 is coupled to body 610. Base portion 630 is shown as substantially rectangular in shape; however, base portion 630 may be any shape. Base portion 630 preferably houses a transceiver 210 therein. In this illustrative embodiment, base portion 630 includes a tab 635 extending therefrom and reinforcing partitions 616. Tab 635 corresponds to a recess (not shown) in housings 305, 306 to properly align receptacle 212 with housings 305, 306.

Body 610 also includes a pair of protrusions 613, which in this illustrative embodiment are sloped outward. Protrusions 613 terminate with a latching surface 614 that is substantially perpendicular to the longitudinal axis of receptacle 212 and the direction of insertion of connector 220, but is sloped slightly in the direction of removal of the connector 220 (toward the end of body 610) as latching surface 614 gets closer to body 610. Latching surface 614 extends to recess 615. When the connector 220 is inserted into receptacle 212, the slope of protrusions 613 gradually urge latches 434 of connector 212 outward around protrusions 613. Once latches 434 of connector 212 are past protrusions 613, they are free to move inward into recess 615, once grip pressure has been removed. After latches 434 move into recesses 615, the latching surfaces of latches 434 abut (engage) their respective latching surfaces 614 of receptacle 212 to secure the connector 220 in receptacle 212. It will be evident to one skilled in the art, that some embodiments of the present invention may not include a protrusion and some embodiments may not include a recess.

As described above, transceiver 210 is aligned with the optic fibers, which allows communication of light data signals, when connector 220 is fully inserted in receptacle 212. FIG. 8 is a schematic representation of transceiver 210 and optic fibers 810. As shown in FIG. 8, optic fibers 810 typically are encased in a cable jacket 811 for protection of optic fibers 810. In this illustrative embodiment, fiber optic cable assembly 215 includes two optic fibers 810, one optic fiber for sending data signals to user premise 106 and one optic fiber 810 for receiving data signals from user premise 106. Fiber optic cable assembly 215, however, may comprise any number of optic fibers 810.

Jacket 811 is stripped from the fiber optic cable at each end of the fiber optic cable. Each optic fiber 810 is then disposed through passage 451 of body 410 and culminates at a corresponding opening 450. That is, a first optic fiber 810 is disposed in passage 451 and culminates at a first opening 450 and a second optic fiber 810 is disposed in passage 451 and culminates at a second opening 450 to align optic fibers 810 with transceiver 210, as described in more detail below.

First and second optic fibers 810 each may be formed, at least in part, of plastic. With such plastic optic fibers, fiber optic cable assembly 215 may be more rugged than a conventional glass optic fibers. Glass optic fibers typically have a higher minimum bend radius and therefore are more sensitive to any bending that may occur during installation. Plastic optic fibers typically are less sensitive to bending and therefore, may be less likely to be damaged during installation. Optic fibers 810 typically have diameters of about 1000 microns; however, the diameters typically range from about 500 microns to about 2000 microns, but may be outside of this range as well.

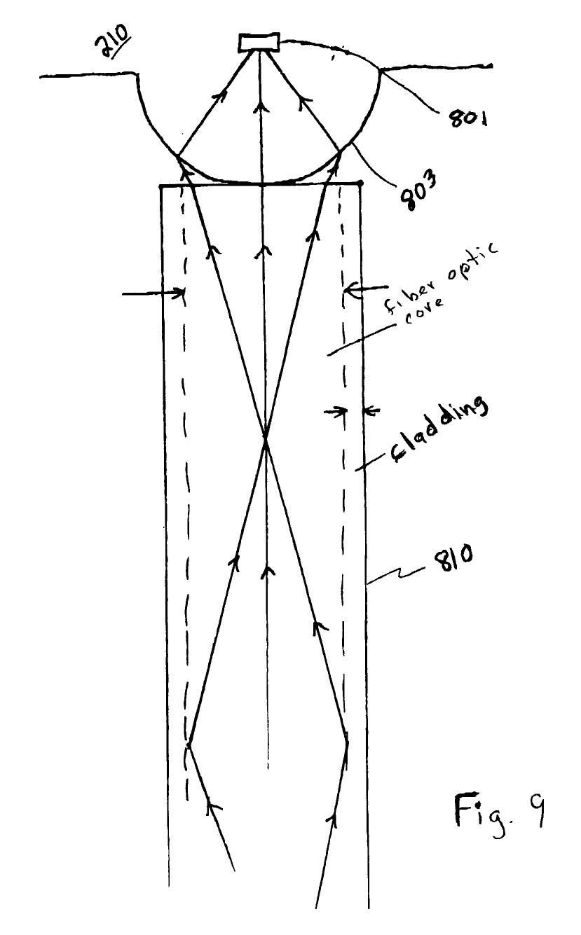

The optic fiber diameter typically is selected based, at least in part, on the size of the transceiver components, as described below. As shown in FIGS. 8 and 9, transceiver 210 comprises a light sensing device 801, and an associated micro-lens, aligned with receptacle 220 to receive light data signals from a first optic fiber 810. Light sensing device 801 has a communication area, which is a micro-lens 803, that is responsive to light and first optic fiber 810 has a communication area for communicating light (i.e., the cross-sectional area of first optic fiber 810), which in this application is used to transmit light. In this embodiment, the communication area of light sensing device 801 is larger than the communication area of first optic fiber 810. In this illustrative embodiment, the communication area of light sensing device 801 has a diameter of about 2000 microns compared to a typical optic fiber diameter of about 1000 microns. The diameter of communication area of light sensing device 801 preferably ranges from about 200 microns to about 10,000 microns although other diameters may be suitable for some applications. The ratio of the communication area of the optic fiber (which is optic fiber diameter to the diameter of light sensing device 801) is preferably about one-to-two. Other embodiments may be designed with a different ratio such as one to one, one-to-one and a half, one-to-two and a half, or one-to-three.

Conventional fiber optic connections are typically made between optic fibers that are about 9 microns in diameter each, and precise alignment is important to minimize any losses. With such a difference in size in the communication areas of light sensing device 801 and first optic fiber 810, the fiber optic connection alignment of the present invention is less sensitive to misalignments between connector 210 and receptacle 220 than conventional fiber optic connections.

Conventional fiber optic connections between a light sensing device and an optic fiber typically are implemented with a lens to focus most of the light from the optic fiber to the light sensing device. Light sensing device 801, however, is adapted to interface directly to first optic fiber 801 without an external lens (and including only a micro-lens). Conventional fiber optic connections typically include a spring to push a ferrule and the optic fiber toward the mating connector, which is not present in most embodiments of the present invention. The ability to tolerate a gap between first optic fiber 810 and the communication area of light sensing device 801, which may be present in some embodiments of the present invention, provides a rugged, less sensitive fiber optic connection. In particular, the fiber optic connection is less sensitive to vibration. Thus, alternate embodiments may include a small gap between first optic fiber 810 and the communication area of light sensing device 801 that is responsive to light.

Light sensing device 801 is preferably a low-power device, for example, consuming less than one-tenth watt of power. In this illustrative embodiment, light sensing device 801 is a photodiode, for example, and is responsive to visible red light. With such visible red light, troubleshooting a transceiver may be simplified in that mere visual observation of red light can determine that data signals are reaching a portion of the power line communication system. The photodiode in this example embodiment is in the form of a chip molded in a plastic housing. The molded plastic also acts as micro-lens 803 to refract the light as shown in FIG. 9.

Transceiver 210 further includes a light producing device 802 and an associated micro-lens aligned with receptacle 202 to send light data signals to a second optic fiber 810. Light producing device 802 has a communication area, which is a micro-lens, that emits light and second optic fiber 810 has a communication area for communicating light (i.e., the cross-sectional area of the fiber), which in this application is used to receive light. The communication area of light producing device 802 is larger than the communication area of second optic fiber 810. In particular, the communication area of light producing device 802 has a diameter of about 3000 microns compared to a typical optic fiber diameter of about 1000 microns. The diameter of the communication area of light producing device 802 ranges from about 500 microns to about 5000 microns, although other diameters outside this range may suitable for some applications. The ratio of the optic fiber diameter to the diameter of light producing device 802 is typically about one-to-three. Other embodiments may be designed with a different ratio such as one-to-one, one-to-one and a half, one-to-two and a half, one-to-four, or two-to-one. FIG. 9, which shows a light sensing device, is also illustrative of a light producing device with the exception of the direction of the arrows indicating the direction of the light transmission (which would be reversed to illustrate a light producing device).

With such a difference in size in the communication areas of light producing device 802 and second optic fiber 801 in this embodiment, the fiber optic connection alignment of the present invention is less sensitive to misalignments between connector 210 and receptacle 220 than conventional fiber optic connections. Light producing device 802 may be adapted to interface directly to second optic fiber 801 without an external lens (and including only a micro-lens). In addition, some embodiments may tolerate a small gap between second optic fiber 810 and the communication area of light producing device 802 that emits light.

Light producing device 802 is preferably a low-power device, for example, consuming less than one-quarter watt of power. Light producing device 802 may be a light emitting diode, a laser, or the like. Light producing device 802 preferably emits visible red light, which simplifies troubleshooting, as described above. The light emitting diode in this example embodiment is in the form of a chip molded in a plastic housing. The molded plastic also acts as a micro-lens to refract the light.

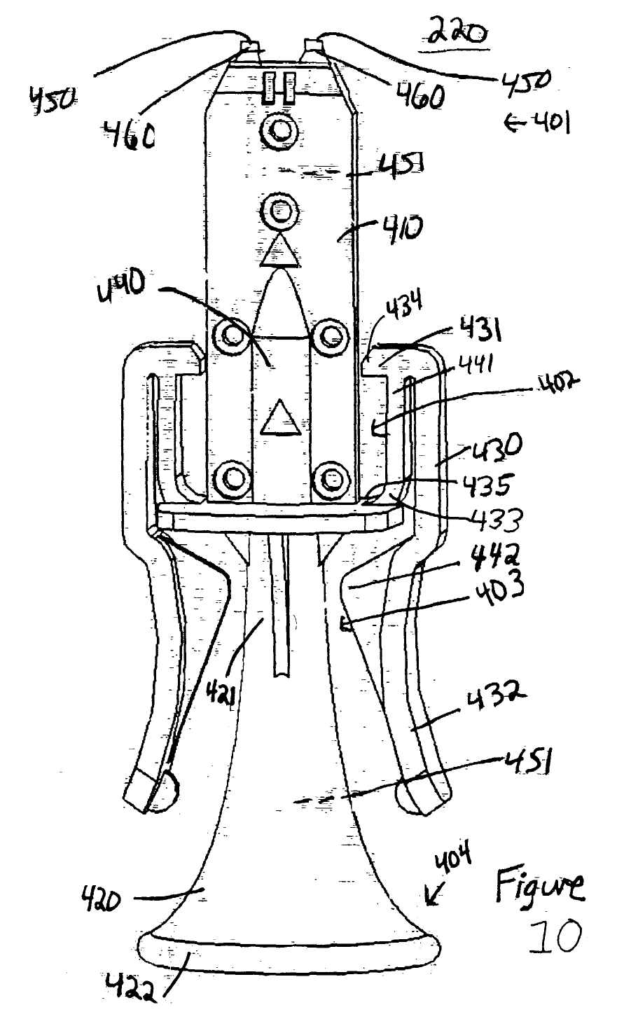

The foregoing embodiment is for illustrative purposes and the present invention may be implemented in various embodiments. For example, FIG. 10 illustrates another embodiment of a connector, which is nearly identical to the embodiment shown in FIGS. 4-6 except for the latching mechanism. In this embodiment, the laterally extending member 435 is coupled to a longitudinal member 441 that is in turn coupled to latching section 431 at pivot area 433. The operation of the latches 430 is generally the same as that of the embodiment described above with respect to the preferred embodiment. However, when the handle portion is gripped and elongated sections 432 urged inward, the inward side 442 of the elongated section 432 abuts the first end 421 of the cable guide body 420 to force the latch 434 outward, pivoting about pivot area 433.

It is to be understood that the foregoing illustrative embodiments have been provided merely for the purpose of explanation and are in no way to be construed as limiting of the invention. Words which have been used herein are words of description and illustration, rather than words of limitation. In addition, all of the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A fiber optic connector for receiving a fiber optic cable, comprising:
a body comprising:
a first end,
a second end, and
a passage from the first end of the body to the second end of the body; and
a cable guide comprising:
a first end coupled to said second end of said body, the first end having a first inner perimeter, and
a second end having a second inner perimeter,
a passage from the first end of the cable guide to the second end of the cable guide, the first end of the cable guide coupled to the second end of the body, the length of the first inner perimeter being less than the length of the second inner perimeter to limit bending of a portion of the fiber optic cable within and proximate the cable guide and allowing radial movement of the fiber optic cable within the cable guide.

2. The fiber optic connector as recited in claim 1, wherein the cable guide limits bending of a portion of the fiber optic cable within and proximate the cable guide to a bend radius greater than a minimum bend radius of the fiber optic cable.

3. The fiber optic connector as recited in claim 1, wherein the cable guide has a generally frustoconical shape, the first end of the cable guide having a first radius and the second end of the cable guide having a second radius, the first radius being less than the second radius.

4. The fiber optic connector as recited in claim 1, wherein the cable guide is generally trumpet shaped, the first end of the cable guide having a first radius and the second end of the cable guide having a second radius, the first radius being less than the second radius.

5. The fiber optic connector as recited in claim 1, wherein the body and the cable guide form a weather-resistant housing for a portion of the fiber optic cable.

6. The fiber optic connector as recited in claim 1, wherein the cable guide is oriented with the first end of the cable guide above the second end of the cable guide, whereby downward moving water is deflected away from the passage of the cable guide.

7. The fiber optic connector as recited in claim 1, wherein the body has at least two openings at the first end of the body, each of the at least two openings being at least partially contiguous with the passage of the body, each of the at least two openings for receiving an optic fiber for communicating light data signals.

8. The fiber optic connector as recited in claim 1, further comprising a pair of latches coupled to the body for securing the connector to a corresponding receptacle.

9. The fiber optic connector as recited in claim 8, wherein the pair of latches form part of a handle to be grasped by a human hand.

10. The fiber optic connector as recited in claim 1, wherein the body passage secures an optic fiber without a ferrule and without a sleeve.

11. The fiber optic connector as recited in claim 1, wherein the body passage defines an optic wave-guide.

12. The fiber optic connector as recited in claim 1, further comprising a fiber optic cable disposed in the body passage and the cable passage, and the fiber optic cable comprises:
a first optic fiber for communicating light data signals; and
a second optic fiber for communicating light data signals.

13. The fiber optic connector as recited in claim 12, wherein the first and second optic fibers each comprise plastic.

14. The fiber optic connector as recited in claim 1, further comprising:
at least one gripping member extending along at least a portion of said cable guide; and
a latching member mechanically coupled to said gripping member and configured to engage a portion of a receptacle;
said gripping member configured to cause said latching member to disengage the portion of the receptacle in response to grip pressure thereby permitting removal of the connector from the receptacle.

15. The fiber optic connector as recited in claim 1, further comprising a key extending from the body for mating with a correspondingly keyed receptacle.

16. The fiber optic connector as recited in claim 1, wherein the body and the cable guide each comprise polyetherimide.

17. The fiber optic connector as recited in claim 1, wherein the body and cable guide are formed as unitary axial segments that are attached together.

18. The fiber optic connector as recited in claim 1, wherein the length of second inner perimeter is greater than about four inches.

19. A fiber optic cable assembly, comprising:
a first fiber optic connector;
a second fiber optic connector, the first and second fiber optic connectors each comprising:
a body comprising:
a first end for interfacing with a fiber optic transceiver,
a second end,
a body passage from the first end of the body to the second end of the body,
a cable guide comprising:
a first end having a first inner perimeter, and
a second end having a second inner perimeter,
a cable guide passage from the first end of the cable guide to the second end of the cable guide, the first end of the cable guide coupled to the second end of the body, the length of the first inner perimeter being less than the length of the second inner perimeter; and
a fiber optic cable having a first end and a second end, the first end of the cable being disposed at the first end of the body of the first fiber optic connector and the second end of the cable being disposed at the first end of the body of the second fiber optic connector;
the fiber optic cable traversing through the body passage of the first fiber optic connector, through the cable guide passage of the first fiber connector, through the cable guide passage of the second fiber connector, and through the body passage of the second fiber optic connector;
the cable guide of the first and second fiber optic connectors defining the cable guide passage to limit bending of a portion of the fiber optic cable within and proximate the cable guide of the respective first and second fiber optic connectors and to allow radial movement of a portion of the fiber optic cable within the cable guide of the respective first and second fiber optic connectors.

20. The fiber optic cable assembly as recited in claim 19, wherein the fiber optic cable comprises:
a first optic fiber for communicating light data signals, the first optic fiber disposed through the cable guide passage of the first fiber optic connector and the cable guide passage of the second fiber optic connector; and
a second optic fiber for communicating light data signals, the second optic fiber disposed through the cable guide passage of the first fiber optic connector and the cable guide passage of the second fiber optic connector.

21. The fiber optic cable assembly as recited in claim 20, wherein the first and second optic fibers each comprise plastic.

22. The fiber optic cable assembly as recited in claim 20, wherein the first and second optic fibers each have diameters of about 1000 micron.

23. The fiber optic cable assembly as recited in claim 19, wherein the body and the cable guide of each connector comprise polyetherimide.

24. The fiber optic cable assembly as recited in claim 19, wherein the length of second inner perimeter of each connector is greater than about four inches.

25. The fiber optic cable assembly as recited in claim 19, wherein the cable guide of each connector comprises a pair of latches coupled to the body and forming a handle to be grasped by a human hand.

26. A fiber optic transceiver for communicating with a fiber optic cable, comprising:
a light sensing device to communicate with a first optic fiber of the fiber optic cable, the light sensing device having a communication area that is responsive to light and the first optic fiber having a communication area for communicating light, the communication area of the light sensing device being larger than the communication area of the first optic fiber; and
a light producing device to communicate with a second optic fiber of the fiber optic cable, the light producing device having a communication area that emits light and the second optic fiber having a communication area for communicating light, the communication area of the light producing device being larger than the communication area of the second optic fiber.

27. The fiber optic transceiver as recited in claim 26, wherein the light producing device is adapted to interface directly to the second optic fiber without an external lens.

28. The fiber optic transceiver as recited in claim 26, wherein the light producing device is adapted to communicate with the second optic fiber with a gap between the communication area of the light producing device that emits light and an end of the second optic fiber.

29. The fiber optic transceiver as recited in claim 26, wherein the light producing device consumes less than one-quarter watt of power.

30. The fiber optic transceiver as recited in claim 26, wherein the communication area of the light producing device that emits light has a diameter of about 3000 microns.

31. The fiber optic transceiver as recited in claim 26, wherein the light producing device is a light emitting diode.

32. The fiber optic transceiver as recited in claim 31, wherein the light emitting diode emits visible light.

33. The fiber optic transceiver as recited in claim 31, wherein the light emitting diode emits visible red light.

34. The fiber optic transceiver as recited in claim 26, wherein the light sensing device is adapted to interface directly to the first optic fiber without an external lens.

35. The fiber optic transceiver as recited in claim 26, wherein the light sensing device is adapted to communicate with the first optic fiber with a gap between the communication area of the light sensing device that is responsive to light and an end of the first optic fiber.

36. The fiber optic transceiver as recited in claim 26, wherein the light sensing device consumes less than one-tenth watt of power.

37. The fiber optic transceiver as recited in claim 26, wherein the communication area of the light sensing device that is responsive to light has a diameter of about 2000 microns.

38. The fiber optic transceiver as recited in claim 26, wherein the light sensing device is a photodiode.

39. The fiber optic transceiver as recited in claim 38, wherein the photodiode is responsive to visible light.

40. The fiber optic transceiver as recited in claim 38, wherein the photodiode is responsive to visible red light.

41. A fiber optic connection system, comprising:
a fiber optic connector, comprising:
a fiber optic cable comprising:
a first optic fiber, and
a second optic fiber,
a body comprising:
a first end for interfacing with a fiber optic transceiver, and
a second end for receiving the fiber optic cable, the body defining a passage from the first end of the body to the second end of the body for communicating optical signals, and
a cable guide comprising:
a first end having a first inner perimeter, and
a second end having a second inner perimeter, the cable guide defining a passage from the first end of the cable guide to the second end of the cable guide for receiving the fiber optic cable, the first end of the cable guide coupled to the second end of the body, the length of the first inner perimeter being less than the length of the second inner perimeter, thereby limiting bending of a portion of the fiber optic cable within and proximate the cable guide and allowing radial movement of the fiber optic cable within the cable guide; and
a receptacle for receiving the fiber optic connector; and
a fiber optic transceiver disposed proximate the receptacle, the transceiver comprising:
a light sensing device aligned with the receptacle to communicate with a first optic fiber, the light sensing device having a communication area that is responsive to light and the first optic fiber having a communication area for communicating light, the communication area of the light sensing device being larger than the communication area of the first optic fiber, and
a light producing device aligned with the receptacle to communicate with a second optic fiber, the light producing device having a communication area that emits light and the second optic fiber having a communication area for communicating light, the communication area of the light producing device being larger than the communication area of the second optic fiber.

42. A connector for receiving a cable, comprising:
a body comprising:
a first end, and
a second end,
a passage from the first end of the body to the second end of the body; and
a cable guide comprising:
a first end coupled to said second end of said body, and
a second end,
a passage from the first end of the cable guide to the second end of the cable guide, said passage being larger at said second end of said cable guide than at said first end of said cable guide to permit greater radial movement of the cable at said second end of said cable guide than at said first end of said cable guide.

43. The connector as recited in claim 42, wherein the cable guide limits bending of a portion of the cable within and proximate the cable guide.

44. The connector as recited in claim 42, wherein the cable guide has a generally frustoconical shape, the first end of the cable guide having a first radius and the second end of the cable guide having a second radius, the first radius being less than the second radius.

45. The connector as recited in claim 42, wherein the cable guide is generally trumpet shaped, the first end of the cable guide having a first radius and the second end of the cable guide having a second radius, the first radius being less than the second radius.

46. The connector as recited in claim 42, wherein the body and the cable guide form a weather-resistant housing for a portion of the cable.

47. The connector as recited in claim 42, wherein the cable guide is oriented with the first end of the cable guide above the second end of the cable guide, whereby downward moving water is deflected away from the passage of the cable guide.

48. The connector as recited in claim 42, wherein the body has at least two openings at the first end of the body, each of the at least two openings being at least partially contiguous with the passage of the body, each of the at least two openings for receiving an optic fiber for communicating light data signals.

49. The connector as recited in claim 42, further comprising a pair of latches coupled to the body for securing and aligning the connector to a corresponding receptacle.

50. The connector as recited in claim 49, wherein the pair of latches form part of a handle to be grasped by a human hand.

51. The connector as recited in claim 42, further comprising:
at least one gripping member extending along at least a portion of said cable guide;
a latching member mechanically coupled to said gripping member and configured to engage a portion of a receptacle; and
said gripping member configured to cause said latching member to disengage the portion of the receptacle in response to grip pressure thereby permitting removal of the connector from the receptacle.
